(19) United States
(12) Patent Application Publication
(10) Pub. No.: US 2006/0243141 A1
(43) Pub. Date: Nov. 2, 2006

(54) Food Container, Strainer, Cooker, and Strained Liquid Collector

(76) Inventors: Loan Mayer, New Haven, VT (US); Dennis P. Mayer, New Haven, VT (US)

Correspondence Address: STAINBROOK & STAINBROOK, LLP, 3558 ROUND BARN BLVD., SUITE 203, SANTA ROSA, CA, 95403, US

(21) Appl. No.: 11/381,302

(22) Filed: May 2, 2006

Related U.S. Application Data
(60) Provisional application No. 60/676,640, filed on May 2, 2005.

(51) Int. Cl. A47J 43/14

(52) U.S. Cl. 99/495

(57) ABSTRACT

A combination food container, strainer, cooker, and strainer liquid collector includes a liquid container portion having an upper rim for connection with either a lid or strainer member. The lid has a channel on its underside sized for receiving and capturing the upper rims of both the liquid container and the strainer, the latter having a skirt with a channel sized identically to that of the lid.

### CROSS REFERENCES TO RELATED APPLICATIONS

The present application claims the benefit of U.S. Provisional Patent Application Ser. No. 60/676,640, filed May 2, 2005 (May 2, 2005).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to food preparation, cooking, and storage apparatus, and more particularly to a combination food container, strainer, cooker, and strained liquid collector.

2. Discussion of Related Art Including Information Disclosed Under 37 CFR §§1.97, 1.98

Several well known food cooking devices function as combination cooking and storage systems for no other reason than that the functional elements adapted for cooking make the apparatus suited for use as a food storage device. For instance, it is well known to store food in baking dishes and cooking pots.

However, numerous food cooking, preparation, and container systems have been specifically developed as combination system. For example, combination microwave steamer and food containers are now well known. Typically, the microwave steamer includes a cooking container, a lid, and a removable perforated steaming platform or colander.

Prior art microwave steamers have notable shortcomings. The colander, for example, is usually inserted into the container portion and must be lifted out by handles (if provided) when cooking is complete. Some steamers have colanders with a pivoting water-bucket type handles. This removal step creates the conditions for scalding from the steam and hot vapors in the container. Next, prior art microwave steamers do not provide separable colander and container portions, each of which can receive the same lid with a substantially air tight snap fit.

Several combination cooking and storage devices have been designed and are illustrative of the art. These include U.S. Pat. No. 5,6090,758, to Hwang, which discloses a hollow spherical container including a hemispherical bowl portion with a foot for placement on a surface, and two quarter-spherical cover halves fixedly attached to rounded rods cradling the bowl portion.

U.S. Pat. No. 4,147,277, to Bateman, teaches a multi-functional serving dish that may be used as a covered serving dish, a covered “steamer” dish either with a single or multi-compartmented colander member, and a covered single or multi-compartmented colander. The closure for the container and/or the colander provides means for condensate formed on the interior of the cover to drain out of the colander and into the container.

U.S. Pat. No. 5,931,333, to Woodnorth, shows U.S. Pat. No. 5,931,333 a container system adapted for use as a microwave steamer. The system includes a container and a lid, and a colander disposed between the lid and the container. The colander has smooth sides with slot openings and integral hand grips which vent vapor trapped between the colander and the container and allow easy lifting of the colander from the container. The lid includes a vent aperture which is a grate that prevents spattering of liquids from the container system. The lid is sealably engaged to the opening of the container.

U.S. Pat. No. 5,139,166, to Smith, discloses a container for holding and draining watery foods and includes a receptacle and a support member positioned on the receptacle and having drain holes. The support member has upwardly projecting ribs to support the food in position above the drain holes so that they are not plugged.

U.S. Pat. No. 5,575,848, to Chedville, shows a device for coating food, having two cylindrical containers open at one end and closed at the other end, and a generally hollow annular coupling member open at both ends and disposed between the two containers. The coupling member has a perforated platform that divides the assembled device into a food containing portion and a batter containing portion, such that when the food is placed in one portion and the container is shaken, batter filters through the perforations to coat the food.

A number of design patents show conceptually related apparatus, including U.S. Pat. No. D353,303 to Davis, D378,724 to Young et al., D425,378 to Gilbertson, and D507,939 to Mitchell, Jr.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Specifically, none show a combination food container, strainer, and cooking apparatus having a lid that tightly fits onto both the colander and container portions, whereby the apparatus can therefore strain, collect, and contain strained liquid in a single apparatus.

### BRIEF SUMMARY OF THE INVENTION

The present invention is a combination food container, strainer, strained liquid collector, and storage container for food and strained liquid. The apparatus includes a liquid container portion having an upper rim for connection with each of the two other primary elements of the invention, namely a lid having a perimeter channel disposed on its underside and sized for receiving and capturing the container rim with a tight fit; and a colander having a skirt with an identically sized channel to accomplish the same result. The result is a combination food container, strainer, cooker, and storage container for food and strained liquid that may be used to store and strain liquid from solid food, including meats, store and strain water washed fruits and vegetables, steam vegetables in a microwave oven or on a stove top, and simultaneously cook and strain meats and other foods in a conventional or microwave oven.

It is therefore an object of the present invention to provide a new and improved combination food container, strainer, cooker, and strainer liquid collector.

It is another object of the present invention to provide a new and improved food container that will passively drain and strain liquid from solid food, including grease from meat, and water from washed vegetables and fruits, while also storing such foodstuffs.

A further object or feature of the present invention is a new and improved food container that may be employed for steaming foods in a microwave or on a stove top, or that may be employed as a vessel for containing food baked in the oven, while also straining liquid from the food into a strained liquid container.

An even further object of the present invention is to provide a novel combination food container, strainer, cooker, and strained liquid container having a single lid that fits tightly over both the strainer element and the strained liquid container element.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an exploded perspective view of the combination food container, strainer, cooker, and strained liquid container of the present invention;

FIG. 2 is a top plan view of the apparatus of FIG. 1;

FIG. 3 is a top plan view of the colander portion of the inventive apparatus;

FIG. 4 is a cross-sectional side view in elevation taken along section line 4-4 of FIGS. 2 and 3;

FIG. 5 is a cross-sectional side view in elevation of the strained liquid container and lid elements only; and

FIG. 6 is an exploded cross-sectional side view in elevation showing the lid and vent closure disk.

### DETAILED DESCRIPTION OF THE INVENTION

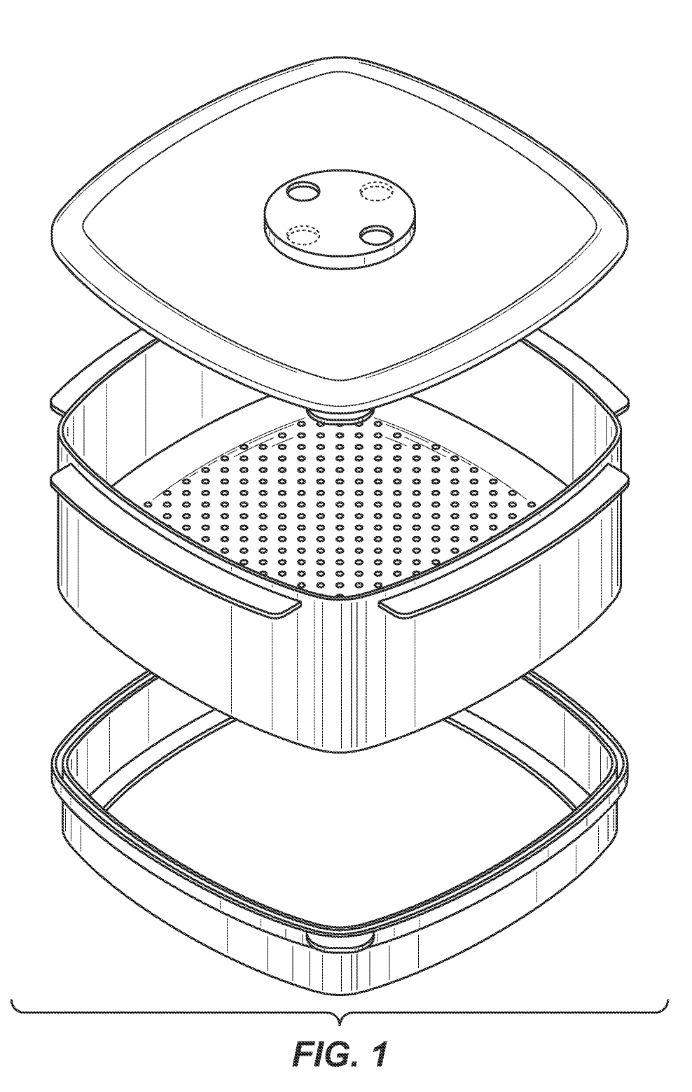

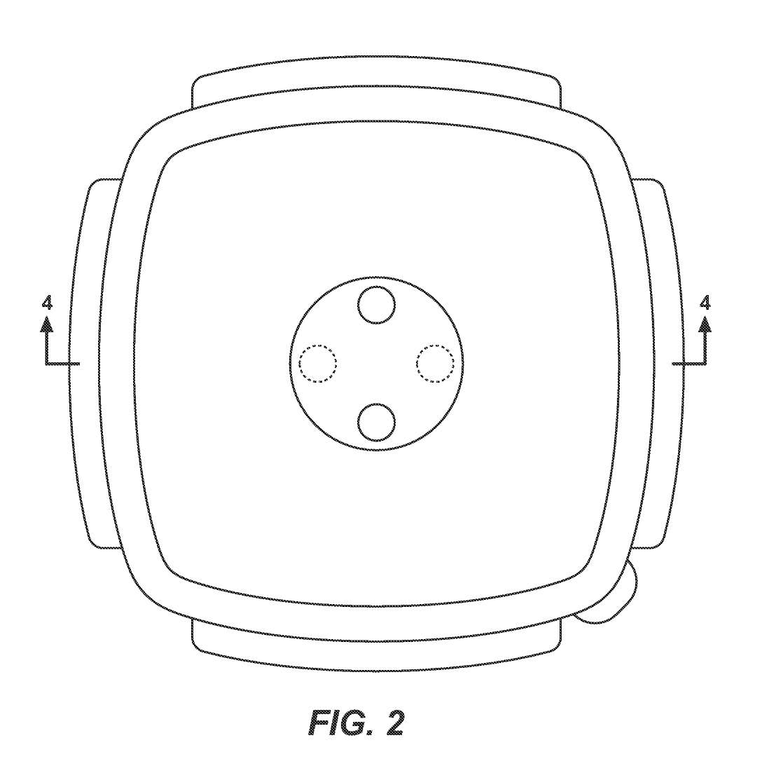

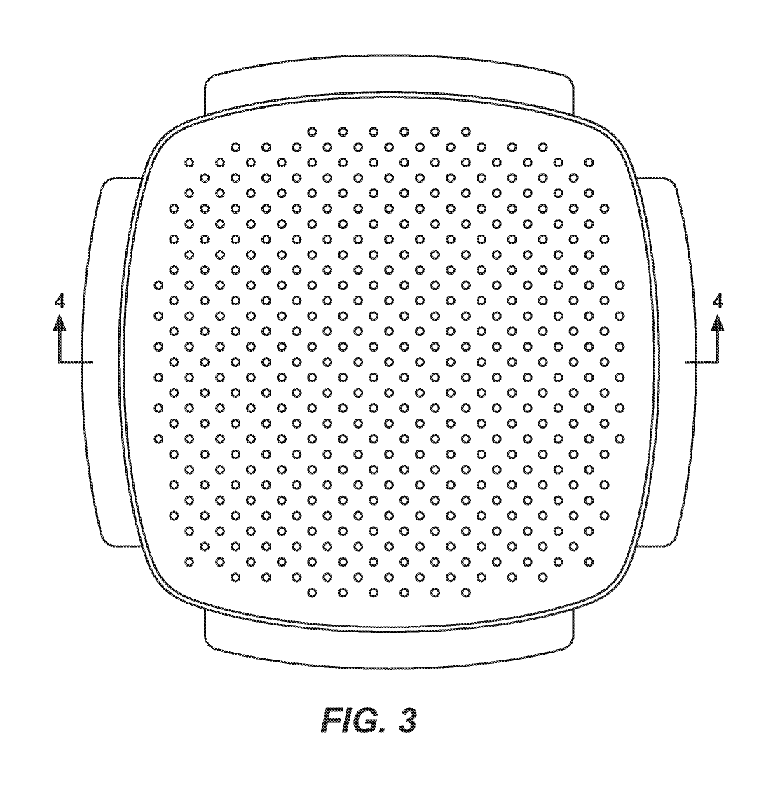

Referring to FIGS. 1 through 6, wherein like reference numerals refer to like components in the various views, there is illustrated therein a new and improved combination food container, strainer, cooker, and strained liquid collection apparatus, generally denominated 100 herein. These figures collectively show a first preferred embodiment of the invention, in which there are three primary structural components, including a strained liquid container 110, a strainer or colander 120, and a lid 130.

The liquid container comprises a solid base 140 surrounded by a wall 150, preferably four-sided, having an upper rim 160 extending the entire perimeter or circumference of the wall. Preferably, the upper portion of the container includes at least one tab or flange 170 that functions as a handle and as means to facilitate bending of the semi-flexible container when it is fabricated from a plastic material. Thus, when an airtight snap fit connection is made with the strainer portion, the liquid container may be easily removed.

The strainer includes a base portion 180 surrounded by a wall 190, again preferably four-sided, having perimeter dimensions generally matching those of the container portion. The height of the wall may be any of a number of suitable and practicable dimensions for containing and cooking foods. The base portion includes openings that may be either slots or holes or a combination thereof, and it provides a platform for the placement of foodstuffs, a barrier keeping the food from liquid retained or collected in the liquid container, and means for liquid to drain from the bottom of the strainer into the liquid container or another liquid receptacle or sink. The upper portion of the wall includes at least two, and preferably four, integral handles 200.

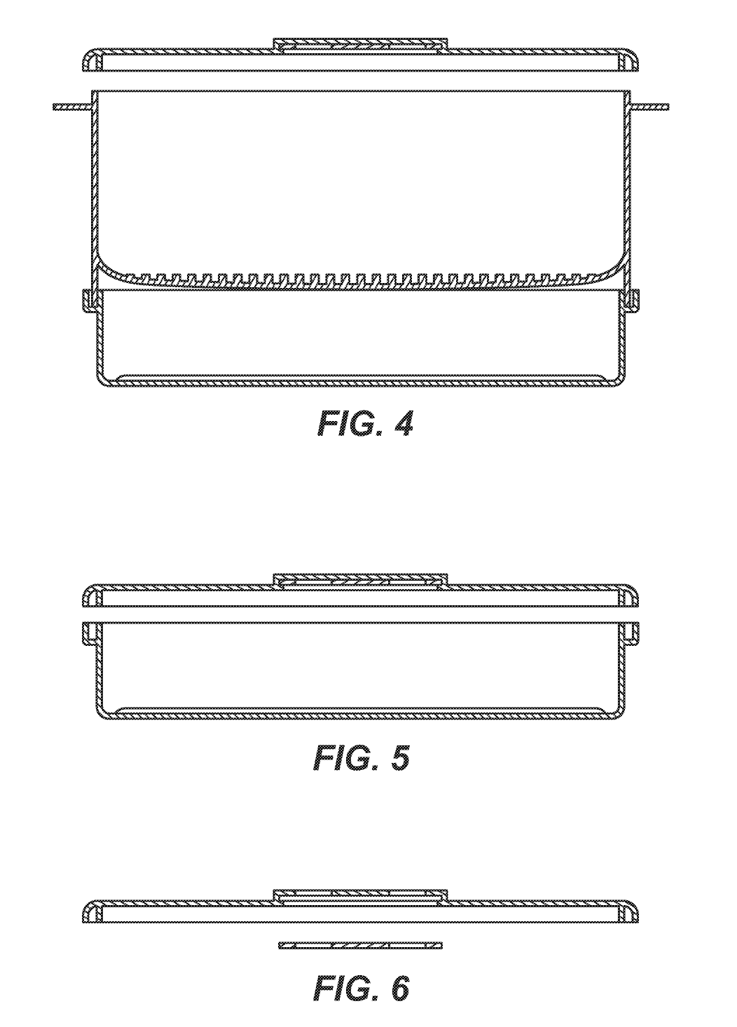

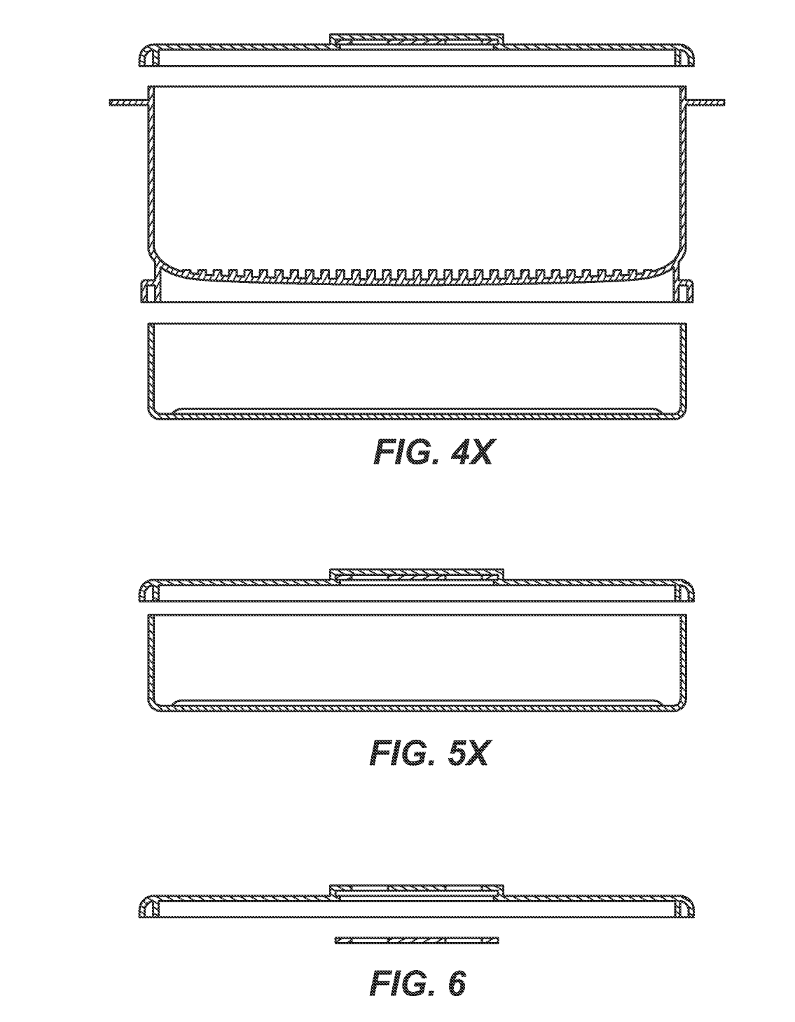

Referring now to FIG. 4, it will be seen that the bottom of the strainer includes an integral skirt 210 extending downwardly from the entire bottom perimeter of the strainer, and the skirt includes a channel 220 sized to fit snugly over the rim of the liquid container. The strainer also includes an upper rim 230, which again matches the perimeter dimensions of the upper rim 160 of the liquid container. The rim extends slightly above the handles 200 to allow placement of the lid over the upper rim.

Referring now to FIGS. 1-2, and 4-6, it will be seen that the lid 130 comprises a interior portion 240 and a perimeter 250 having a channel 260 for tight placement over either the upper rim 230 of the strainer or the upper rim 160 of the liquid container. The lid may further include a vent 270, which may be any of a number of designs, but which preferably comprises a disk 280 rotatably secured within a disk pocket 290 in the central portion 300 of the lid. The disk includes openings 310 that may be selectively brought into alignment with openings 320 in the lid interior portion to open the interior compartment of the strainer and/or liquid container to the outside air and thus allow water vapor or steam to escape. Alternatively, it may be selectively rotated so that its openings are out of alignment with those of the lid interior portion to close and seal the interior compartment of the strainer and/or liquid container. The configuration of the disk pocket is shown in FIGS. 4-6. It will be appreciated that the pocket is circular and has a slightly larger diameter than the disk, thus permitting rotation of the disk within the pocket. The pocket is open on the bottom so that the openings in the disk can be engaged with a finger or a utensil and rotated, as described above.

When used for washing and straining fruits and vegetables, the foodstuffs are placed in the strainer and washed under running water. Excess water is allowed to run off into a sink, and the strainer is then placed onto the rim of the liquid container and the lid is placed onto the rim of the strainer. The vent may be open if the vegetables or fruit are to be stored in a refrigerator in the manner of a crisper. While refrigerated or otherwise set aside, water will continue to drain off the foodstuffs and into the liquid container.

When used for cooking, uncooked foods (vegetables, rice, pasta, meats, etc) are placed in the strainer for cooking. If steam cooking is called for, the liquid container is partially filled with water and the strainer is fitted over the upper rim of the liquid container; if not, the strainer is fitted onto an empty liquid container. The lid is then securely placed on the upper rim of the strainer and the vent is appropriately opened or left closed (depending on the cooking requirement and the need for venting steam and vapor). The now combined apparatus is placed in an oven (either microwave or conventional, depending on the appparatus material), and the food is cooked by direct microwave heating or by hot steam or liquid in the container system. When the cooking is complete, the vent can be opened to vent remaining steam, or it may be closed or left closed, again depending on the cooking needs. When it is desired, the lid is removed from the colander and the food can be directly removed.

Thus, in its most essential aspect, the present invention is seen to be a combination food container, strainer, cooker, and strained liquid collector, made of any of a number of materials, and comprising: (1) a liquid container portion having a solid base surrounded by a container wall with an upper rim; (2) a strainer portion having a base with openings (slots, holes, or both), a strainer wall with an upper rim, and a skirt extending downwardly from the bottom of the strainer base and having a channel sized for placement onto the upper rim of the container wall; and (3) a lid having a perimeter with a channel sized to fit over the upper rims of both the liquid container and the strainer such that the lid may be selectively placed on either the strainer or the liquid container, and such that the liquid container, strainer, and lid can be arranged in a stacked relationship with the strainer interposed between the liquid container and the lid, and in such a stacked relationship the lid provides a closure for both the strainer and the liquid container.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

It will be readily appreciated that all of the elements of the inventive apparatus may be fabricated from glass, ceramic, plastic, cast iron, coated cast iron, aluminum, coated aluminum, stainless steel, and the like. When fabricated from plastic, it may function primarily as a combination apparatus primarily adapted for use with microwave ovens. When fabricated from other metal, the apparatus may be directed primarily for use in a conventional oven and on a stove top. When fabricated from glass or ceramic, the apparatus may be adapted for use in both a microwave oven and a conventional oven.

It will also be readily appreciated that the inventive apparatus may assume any of a number of cross-sectional shapes when viewed from above—circular, square, oval, rectangular, and so on. No shape is considered inherently superior to any other shape, so it is to be understood that the generally square shape of the embodiment shown in the drawings is for purposes of illustration only.

Therefore, the above description and illustrations should not be construed as limiting the scope of the invention, which is defined by the appended claims.

What is claimed as invention is:

1. A combination food container, strainer, cooker, and strained liquid collector, comprising:
a liquid container having a solid base surrounded by a container wall with an upper rim;
a strainer having a base with openings, a strainer wall with an upper rim, and a skirt depending downwardly from said perforated base and having a channel sized for placement onto said upper rim of said container wall; and
a lid having a perimeter with a channel sized to fit over the upper rims of both of said liquid container and said strainer such that said lid may be selectively placed on either of said strainer and said liquid container;
whereby said liquid container, said strainer, and said lid can be arranged in a stacked relationship with said strainer interposed between said liquid container and said lid.

2. The apparatus of claim 1, wherein said upper rim of said container wall extends around the entire upper perimeter of said container wall.

3. The apparatus of claim 1, wherein said upper rim of said strainer wall extends around the entire upper perimeter of said strainer wall.

4. The apparatus of claim 1, wherein said liquid container includes at least one outwardly projecting tab proximate said container wall upper rim.

5. The apparatus of claim 1, wherein when said liquid container, said strainer, and said lid are in a stacked relationship, said lid provides a seal for both of said strainer and said liquid container.

6. The apparatus of claim 6, wherein said seal is substantially air tight.

7. The apparatus of claim 1, wherein said apparatus is fabricated from material selected from the group consisting of glass, ceramic, plastic, cast iron, stainless steel, aluminum, and coated aluminum.

8. The apparatus of claim 1, wherein said lid includes a vent.

9. The apparatus of claim 8, wherein said vent is disposed in the central portion of said lid.

10. The apparatus of claim 8, wherein said lid includes holes and where said vent comprises a disk rotatably disposed over the holes in said lid and includes holes that may be selectively brought into alignment with the holes in said lid by rotating said disk.

11. The apparatus of claim 10, wherein said lid includes an integral pocket in which said disk is rotatably disposed.

12. The apparatus of claim 10, wherein said disk is mounted on an axle disposed on said lid.

13. The apparatus of claim 1, wherein said liquid container wall and said strainer wall are four-sided.

14. The apparatus of claim 1, wherein said liquid container wall and said strainer wall are round.

15. The apparatus of claim 1, wherein said liquid container has an upper portion and a lower portion and said base is disposed in said lower portion.

16. The apparatus of claim 1, wherein said openings in said base are, holes, slots, or a combination thereof.
